(19) United States
(12) Patent Application Publication
(10) Pub. No.: US 2013/0297728 A1
(43) Pub. Date: Nov. 7, 2013

(54) SELECTIVELY EXCHANGING METADATA IN A WIRELESS COMMUNICATIONS SYSTEM

(71) Applicant: QUALCOMM ISKOOT, INC., San Diego, CA (US)

(72) Inventors: Isaac David Guedalia, Bet Shemesh (IL); Gabriel Berelejis, Bet Shemesh (IL); Eitan Mizrotsky, Jerusalem (IL)

(73) Assignee: Qualcomm ISkoot, Inc., San Diego, CA (US)

(21) Appl. No.: 13/874,098

(22) Filed: Apr. 30, 2013

Related U.S. Application Data
(60) Provisional application No. 61/641,174, filed on May 1, 2012.

(51) Int. Cl. H04W 8/24

(52) U.S. Cl. CPC H04W 8/24
USPC 709/217

(57) ABSTRACT

In an embodiment, data scheduled for transmission by an apparatus is determined to include multiple elements with (i) a first portion of substantially non-redundant information and (ii) a second portion with information that is redundant to each of the multiple elements. The apparatus generates a composite representation of the redundant information, and transmits the composite representation of the redundant information to a recipient. The recipient determines reconstruction information by which the composite representation of the redundant information can be used in conjunction with the first portions of the substantially non-redundant information to reconstruct the multiple elements. After obtaining the first portions of the substantially non-redundant information, the recipient reconstructs the multiple elements based on the first portions of the substantially non-redundant information, the reconstruction information and the composite representation of the redundant information.

### CLAIM OF PRIORITY UNDER 35 USC. §119

The present application for patent claims priority to Provisional Application No. 61/641,174 entitled “SELECTIVELY EXCHANGING METADATA IN A WIRELESS COMMUNICATIONS SYSTEM”, filed May 1, 2012, by the same inventors as the subject application, assigned to the assignee hereof and hereby expressly incorporated by reference herein.

### BACKGROUND OF THE INVENTION

1. Field of the Invention

Embodiments relate to selectively exchanging metadata in a wireless communications system.

2. Description of the Related Art

Bandwidth over communications systems, such as wireless communications systems, can be expensive or limited. Conventional mechanisms for reducing bandwidth consumption of a subscriber device include diverting the subscriber device to cheaper protocols (e.g., WiFi), accessing the wireless communication systems during off-peak hours and so on.

### SUMMARY

In an embodiment, data scheduled for transmission by an apparatus is determined to include multiple elements with (i) a first portion of substantially non-redundant information and (ii) a second portion with information that is redundant to each of the multiple elements. The apparatus generates a composite representation of the redundant information, and transmits the composite representation of the redundant information to a recipient. The recipient determines reconstruction information by which the composite representation of the redundant information can be used in conjunction with the first portions of the substantially non-redundant information to reconstruct the multiple elements. After obtaining the first portions of the substantially non-redundant information, the recipient reconstructs the multiple elements based on the first portions of the substantially non-redundant information, the reconstruction information and the composite representation of the redundant information.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 is a diagram of a wireless network architecture that supports access terminals and access networks in accordance with at least one embodiment of the invention.

FIG. 2 illustrates a core network according to an embodiment of the present invention.

FIG. 3 is an illustration of a given user equipment (UE) in accordance with at least one embodiment of the invention.

FIG. 4A illustrates a communication device that includes logic configured to perform functionality in accordance with an embodiment of the invention.

FIG. 4B illustrates a server in accordance with an embodiment of the invention.

FIG. 5 illustrates a client-server architecture in accordance with an embodiment of the present invention.

FIG. 6 illustrates a process of uploading data from a given application that is executing on the UE to a given target server via the mobile optimized data (MOD) server in accordance with an embodiment of the invention.

FIG. 7A illustrates a process of uploading data to the given application that is executing on the UE from the given target server via the MOD server in accordance with an embodiment of the invention.

FIG. 7B illustrates a continuation of the process of FIG. 7A in accordance with an embodiment of the invention.

FIG. 7C illustrates a continuation of the process of FIG. 7A in accordance with an embodiment of the invention.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A High Data Rate (HDR) subscriber station, referred to herein as user equipment (UE), may be mobile or stationary, and may communicate with one or more access points (APs), which may be referred to as Node. Bs. A UE transmits and receives data packets through one or more of the Node Bs to a Radio Network Controller (RNC). The Node Bs and RNC are parts of a network called a radio access network (RAN). A radio access network can transport voice and data packets between multiple access terminals.

The radio access network may be further connected to additional networks outside the radio access network, such core network including specific carrier related servers and devices and connectivity to other networks such as a corporate intranet, the Internet, public switched telephone network (PSTN), a Serving General Packet Radio Services (GPRS) Support Node (SGSN), a Gateway GPRS Support Node (GGSN), and may transport voice and data packets between each UE and such networks. A UE that has established an active traffic channel connection with one or more Node Bs may be referred to as an active UE, and can be referred to as being in a traffic state. A UE that is in the process of establishing an active traffic channel (TCH) connection with one or more Node Bs can be referred to as being in a connection setup state. A UE may be any data device that communicates through a wireless channel or through a wired channel. A UE may further be any of a number of types of devices including but not limited to PC card, compact flash device, external or internal modem, or wireless or wireline phone. The communication link through which the UE sends signals to the Node B(s) is called an uplink channel (e.g., a reverse traffic channel, a control channel, an access channel, etc.). The communication link through which Node B(s) send signals to a UE is called a downlink channel (e.g., a paging channel, a control channel, a broadcast channel, a forward traffic channel, etc.). As used herein the term traffic channel (TCH) can refer to either an uplink/reverse or downlink/forward traffic channel.

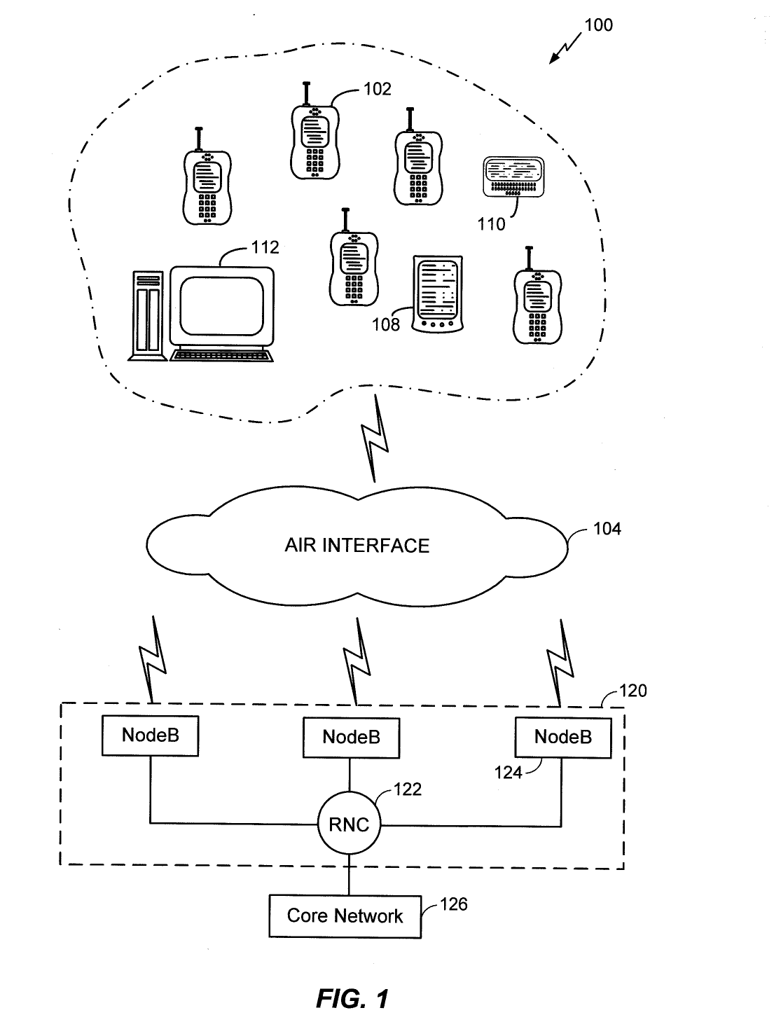

FIG. 1 illustrates a block diagram of one exemplary embodiment of a wireless communications system 100 in accordance with at least one embodiment of the invention. System 100 can contain UEs, such as cellular telephone 102, in communication across an air interface 104 with an access network or radio access network (RAN) 120 that can connect the UE 102 to network equipment providing data connectivity between a packet switched data network (e.g., an intranet, the Internet, and/or core network 126) and the UEs 102, 108, 110, 112. As shown here, the UE can be a cellular telephone 102, a personal digital assistant or tablet computer 108, a pager or laptop 110, which is shown here as a two-way text pager, or even a separate computer platform 112 that has a wireless communication portal. Embodiments of the invention can thus be realized on any form of UE including a wireless communication portal or having wireless communication capabilities, including without limitation, wireless modems, PCMCIA cards, personal computers, telephones, or any combination or sub-combination thereof. Further, as used herein, the term “UE” in other communication protocols (i.e., other than W-CDMA) may be referred to interchangeably as an “access terminal,” “AT,” “wireless device,” “client device,” “mobile terminal,” “mobile station” and variations thereof.

Referring back to FIG. 1, the components of the wireless communications system 100 and interrelation of the elements of the exemplary embodiments of the invention are not limited to the configuration illustrated. System 100 is merely exemplary and can include any system that allows remote UEs, such as wireless client computing devices 102, 108, 110, 112 to communicate over-the-air between and among each other and/or between and among components connected via the air interface 104 and RAN 120, including, without limitation, core network 126, the Internet, PSTN, SGSN, GGSN and/or other remote servers.

The RAN 120 controls messages (typically sent as data packets) sent to a RNC 122. The RNC 122 is responsible for signaling, establishing, and tearing down bearer channels (i.e., data channels) between a Serving General Packet Radio Services (GPRS) Support Node (SGSN) and the UEs 102/108/110/112. If link layer encryption is enabled, the RNC 122 also encrypts the content before forwarding it over the air interface 104. The function of the RNC 122 is well-known in the art and will not be discussed further for the sake of brevity. The core network 126 may communicate with the RNC 122 by a network, the Internet and/or a public switched telephone network (PSTN). Alternatively, the RNC 122 may connect directly to the Internet or external network. Typically, the network or Internet connection between the core network 126 and the RNC 122 transfers data, and the PSTN transfers voice information. The RNC 122 can be connected to multiple Node Bs 124. In a similar manner to the core network 126, the RNC 122 is typically connected to the Node Bs 124 by a network, the Internet and/or PSTN for data transfer and/or voice information. The Node Bs 124 can broadcast data messages wirelessly to the UEs, such as cellular telephone 102. The Node Bs 124, RNC 122 and other components may form the RAN 120, as is known in the art. However, alternate configurations may also be used and the invention is not limited to the configuration illustrated. For example, in another embodiment the functionality of the RNC 122 and one or more of the Node Bs 124 may be collapsed into a single “hybrid” module having the functionality of both the RNC 122 and the Node B(s) 124.

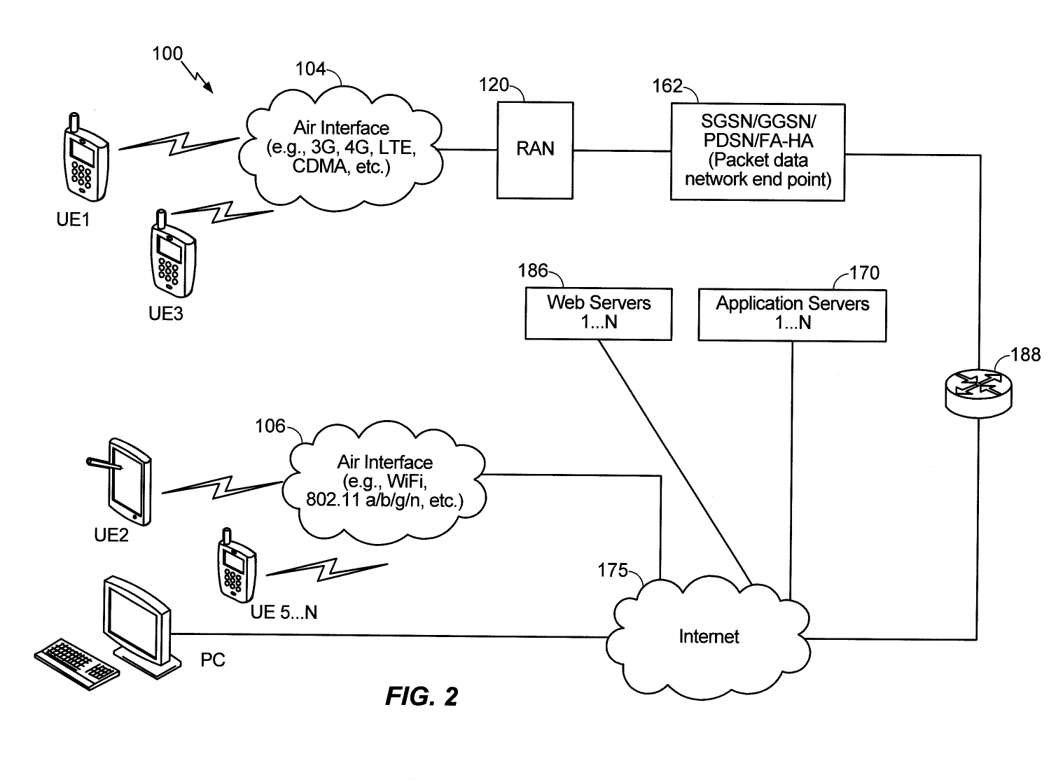

FIG. 2 illustrates an example of the wireless communications system 100 of FIG. 1 in more detail. In particular, referring to FIG. 2, UEs 1 . . . N are shown as connecting to the RAN 120 at locations serviced by different packet data network end-points. The illustration of FIG. 2 is specific to W-CDMA systems and terminology, although it will be appreciated how FIG. 2 could be modified to conform with various other wireless communications protocols (e.g., LTE, EV-DO, UMTS, etc.) and the various embodiments are not limited to the illustrated system or elements.

UEs 1 and 3 connect to the RAN 120 at a portion served by a first packet data network endpoint 162 (e.g., which may correspond to SGSN, GGSN, PDSN, a home agent (HA), a foreign agent (FA), PGW/SGW in LTE, etc.). The first packet data network end-point 162 in turn connects, via the routing unit 188, and through the routing unit 188, to the Internet 175. Through the Internet 175, the UEs 1 and 3 can connect to any of application servers 1 . . . N 170 that are configured to provide one or more Internet-based services (e.g., streaming video, etc.). Also, through the Internet 175, UEs 1 and 3 can connect to any of web servers 1 . . . N (e.g., providing web-content or web browsing features), 186. UEs 2 and 5, . . . N connect to the Internet 175 via a different air interface 106, such as a WiFi or IEEE 802.11a/b/g/n interface via a local wireless access point or hotspot. UE 4 connects directly to the Internet 175 via a wired connection (e.g., a LAN or Ethernet connection), and through the Internet 175 can then connect to any of the system components described above.

Referring to FIG. 2, UEs 1, 3 and 4 . . . N are illustrated as wireless cell-phones, UE 2 is illustrated as a wireless tablet- and/or laptop PC. However, in other embodiments, it will be appreciated that the wireless communication system 100 can connect to any type of UE, and the examples illustrated in FIG. 2 are not intended to limit the types of UEs that may be implemented within the system.

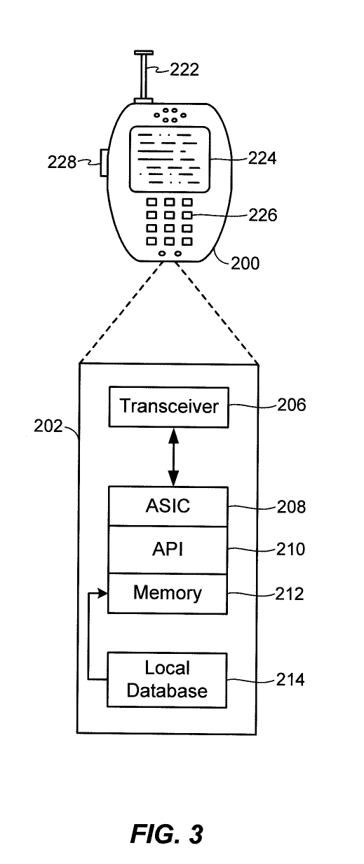

Referring to FIG. 3, a UE 200, (here a wireless device), such as a cellular telephone, has a platform 202 that can receive and execute software applications, data and/or commands transmitted from the RAN 120 that may ultimately come from the core network 126, the Internet 175 and/or other remote servers and networks. The platform 202 can include a transceiver 206 operably coupled to an application specific integrated circuit (“ASIC” 208), or other processor, microprocessor, logic circuit, or other data processing device. The ASIC 208 or other processor executes the application programming interface (“API’) 210 layer that interfaces with any resident programs in the memory 212 of the wireless device. The memory 212 can be comprised of read-only or random-access memory (RAM and RUM), EEPROM, flash cards, or any memory common to computer platforms. The platform 202 also can include a local database 214 that can hold applications not actively used in memory 212. The local database 214 is typically a flash memory cell, but can be any secondary storage device as known in the art, such as magnetic media, EEPROM, optical media, tape, soft or hard disk, or the like. The internal platform 202 components can also be operably coupled to external devices such as antenna 222, display 224, push-to-talk button 228 and keypad 226 among other components, as is known in the art.

Accordingly, an embodiment of the invention can include a UE including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 208, memory 212, API 210 and local database 214 may all be used cooperatively to load, store and execute the various functions disclosed herein and thus the logic to perform these functions may be distributed over various elements. Alternatively, the functionality could be incorporated into one discrete component. Therefore, the features of the UE 200 in FIG. 3 are to be considered merely illustrative and the invention is not limited to the illustrated features or arrangement.

The wireless communication between the UE 102 or 200 and the RAN 120 can be based on different technologies or transport mechanisms, such as code division multiple access (CDMA), W-CDMA, time division multiple access (TDMA), frequency division multiple access (FDMA), Orthogonal Frequency Division Multiplexing (OFDM), the Global System for Mobile Communications (GSM), 3GPP Long Term Evolution (LTE) or other protocols that may be used in a wireless communications network or a data communications network. Accordingly, the illustrations provided herein are not intended to limit the embodiments of the invention and are merely to aid in the description of aspects of embodiments of the invention.

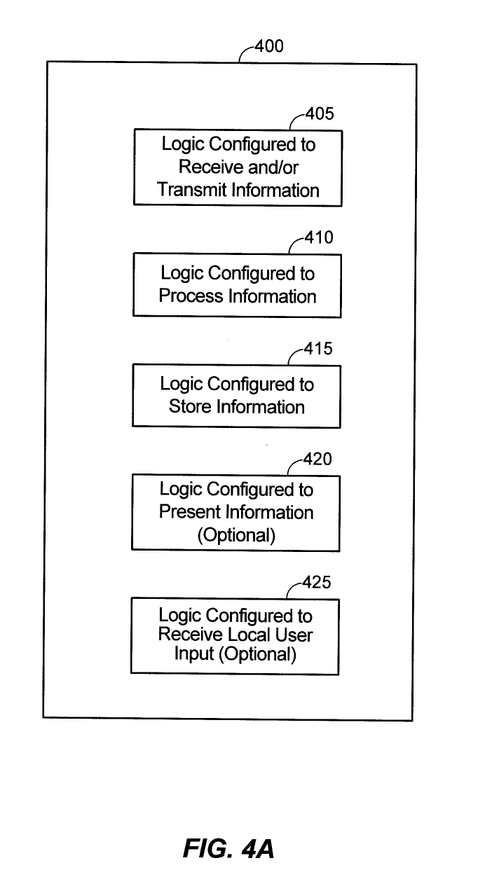

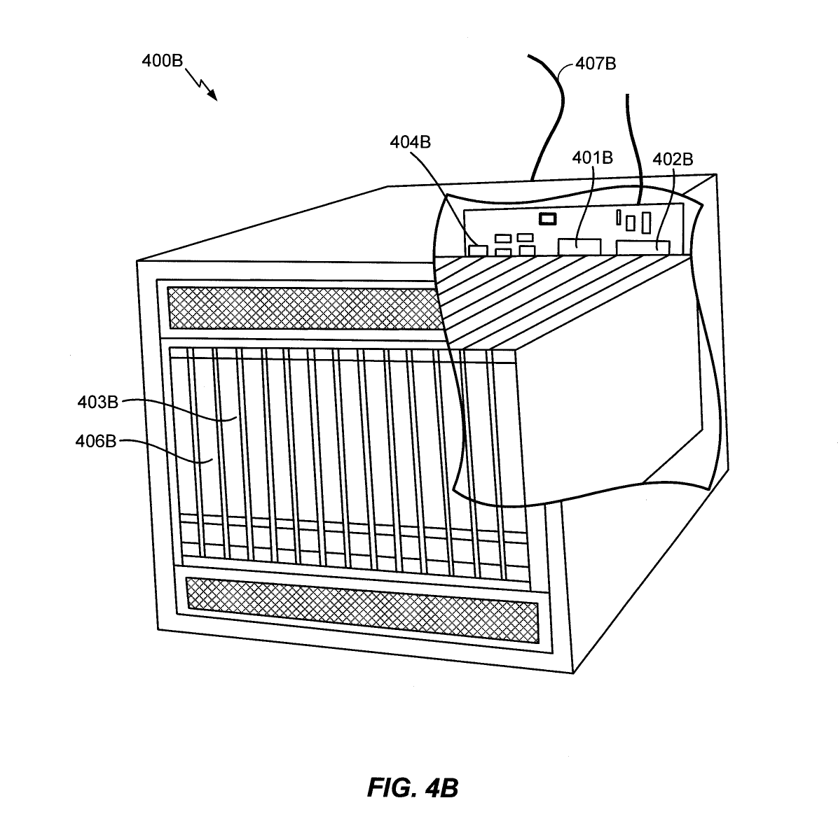

FIG. 4A illustrates a communication device 400 that includes logic configured to perform functionality. The communication device 400 can correspond to any of the above-noted communication devices, including but not limited to UEs 102, 108, 110, 112 or 200, Node Bs or base stations 120, the RNC or base station controller 122, a packet data network end-point (e.g., SGSN, GGSN, a Mobility Management Entity (MME) in Long Term Evolution (LTE), etc.), any of the servers 170 through 186, etc. Thus, communication device 400 can correspond to any electronic device that is configured to communicate with (or facilitate communication with) one or more other entities over a network.

Referring to FIG. 4A, the communication device 400 includes logic configured to receive and/or transmit information 405. In an example, if the communication device 400 corresponds to a wireless communications device (e.g., UE 200, Node B 124, etc.), the logic configured to receive and/or transmit information 405 can include a wireless communications interface (e.g., Bluetooth, WiFi, 2G, 3G, etc.) such as a wireless transceiver and associated hardware (e.g., an RF antenna, a MODEM, a modulator and/or demodulator, etc.). In another example, the logic configured to receive and/or transmit information 405 can correspond to a wired communications interface (e.g., a serial connection, a USB or Firewire connection, an Ethernet connection through which the Internet 175 can be accessed, etc.). Thus, if the communication device 400 corresponds to some type of network-based server (e.g., SGSN, GGSN, application server 170, etc.), the logic configured to receive and/or transmit information 405 can correspond to an Ethernet card, in an example, that connects the network-based server to other communication entities via an Ethernet protocol. In a further example, the logic configured to receive and/or transmit information 405 can include sensory or measurement hardware by which the communication device 400 can monitor its local environment (e.g., an accelerometer, a temperature sensor, a light sensor, an antenna for monitoring local RF signals, etc.). The logic configured to receive and/or transmit information 405 can also include software that, when executed, permits the associated hardware of the logic configured to receive and/or transmit information 405 to perform its reception and/or transmission function(s). However, the logic configured to receive and/or transmit information 405 does not correspond to software alone, and the logic configured to receive and/or transmit information 405 relies at least in part upon hardware to achieve its functionality.

Referring to FIG. 4A, the communication device 400 further includes logic configured to process information 410. In an example, the logic configured to process information 410 can include at least a processor. Example implementations of the type of processing that can be performed by the logic configured to process information 410 includes but is not limited to performing determinations, establishing connections, making selections between different information options, performing evaluations related to data, interacting with sensors coupled to the communication device 400 to perform measurement operations, converting information from one format to another (e.g., between different protocols such as .wmv to .avi, etc.), and so on. For example, the processor included in the logic configured to process information 410 can correspond to a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 410 can also include software that, when executed, permits the associated hardware of the logic configured to process information 410 to perform its processing function(s). However, the logic configured to process information 410 does not correspond to software alone, and the logic configured to process information 410 relies at least in part upon hardware to achieve its functionality.

Referring to FIG. 4A, the communication device 400 further includes logic configured to store information 415. In an example, the logic configured to store information 415 can include at least a non-transitory memory and associated hardware (e.g., a memory controller, etc.). For example, the non-transitory memory included in the logic configured to store information 415 can correspond to RAM memory, flash memory, ROM memory, EPROM memory, EEPROM memory, registers, hard disk, a removable disk, a CD-ROM, or any other form of storage medium known in the art. The logic configured to store information 415 can also include software that, when executed, permits the associated hardware of the logic configured to store information 415 to perform its storage function(s). However, the logic configured to store information 415 does not correspond to software alone, and the logic configured to store information 415 relies at least in part upon hardware to achieve its functionality.

Referring to FIG. 4A, the communication device 400 further optionally includes logic configured to present information 420. In an example, the logic configured to present information 420 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 400. For example, if the communication device 400 corresponds to UE 200 as shown in FIG. 3, the logic configured to present information 420 can include the display 224. In a further example, the logic configured to present information 420 can be omitted for certain communication devices, such as network communication devices that do not have a local user (e.g., network switches or routers, remote servers, etc.). The logic configured to present information 420 can also include software that, when executed, permits the associated hardware of the logic configured to present information 420 to perform its presentation function(s). However, the logic configured to present information 420 does not correspond to software alone, and the logic configured to present information 420 relies at least in part upon hardware to achieve its functionality.

Referring to FIG. 4A, the communication device 400 further optionally includes logic configured to receive local user input 425. In an example, the logic configured to receive local user input 425 can include at least a user input device and associated hardware. For example, the user input device can include buttons, a touch-screen display, a keyboard, a camera, an audio input device (e.g., a microphone or a port that can carry audio information such as a microphone jack, etc.), and/or any other device by which information can be received from a user or operator of the communication device 400. For example, if the communication device 400 corresponds to UE 200 as shown in FIG. 3, the logic configured to receive local user input 425 can include the display 224 (if implemented a touch-screen), keypad 226, etc. In a further example, the logic configured to receive local user input 425 can be omitted for certain communication devices, such as network communication devices that do not have a local user (e.g., network switches or routers, remote servers, etc.). The logic configured to receive local user input 425 can also include software that, when executed, permits the associated hardware of the logic configured to receive local user input 425 to perform its input reception function(s). However, the logic configured to receive local user input 425 does not correspond to software alone, and the logic configured to receive local user input 425 relies at least in part upon hardware to achieve its functionality.

Referring to FIG. 4A, while the configured logics of 405 through 425 are shown as separate or distinct blocks in FIG. 4A, it will be appreciated that the hardware and/or software by which the respective configured logic performs its functionality can overlap in part. For example, any software used to facilitate the functionality of the configured logics of 405 through 425 can be stored in the non-transitory memory associated with the logic configured to store information 415, such that the configured logics of 405 through 425 each performs their functionality (i.e., in this case, software execution) based in part upon the operation of software stored by the logic configured to store information 415. Likewise, hardware that is directly associated with one of the configured logics can be borrowed or used by other configured logics from time to time. For example, the processor of the logic configured to process information 410 can format data into an appropriate format before being transmitted by the logic configured to receive and/or transmit information 405, such that the logic configured to receive and/or transmit information 405 performs its functionality (i.e., in this case, transmission of data) based in part upon the operation of hardware the processor) associated with the logic configured to process information 410.

It will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the embodiments described below in more detail.

The various embodiments may be implemented on any of a variety of commercially available server devices, such as server 400B illustrated in FIG. 4B. In an example, the server 400B may correspond to one example configuration of the application server 170 described above. In FIG. 4B, the server 400B includes a processor 401B coupled to volatile memory 402B and a large capacity nonvolatile memory, such as a disk drive 403B. The server 400B may also include a floppy disc drive, a writeable compact disc (CD) or writeable DVD disc drive 406B coupled to the processor 401B. The server 400B may also include network access ports 404B coupled to the processor 401 for establishing data connections with a network 407B, such as a local area network coupled to other broadcast system computers and servers or to the Internet. In context with FIG. 4A, it will be appreciated that the server 400B of FIG. 4B illustrates one example implementation of the communication device 400, whereby the logic configured to transmit and/or receive information 405 corresponds to the network access ports 404B used by the server 400B to communicate with the network 407B, the logic configured to process information 410 corresponds to the processor 401B, and the logic configuration to store information 415 corresponds to any combination of the volatile memory 402B, the disk drive 403B and/or the disc drive 406B. The optional logic configured to present information 420 and the optional logic configured to receive local user input 425 are not shown explicitly in FIG. 4B and may or may not be included therein. Thus, FIG. 4B helps to demonstrate that the communication device 400 may be implemented as a server, in addition to a UE implementation as in FIG. 3.

UEs can be configured to execute a number of different mobile applications that, when executed, are configured to interface with a number of external servers (e.g., the application servers 170, the web servers 186, etc.) via the RAN 120. For example, a mobile application for Facebook may be configured to contact a given application server 170 controlled by Facebook, a mobile web application may be configured to contact a number of different web servers 186 to retrieve web content, and so on.

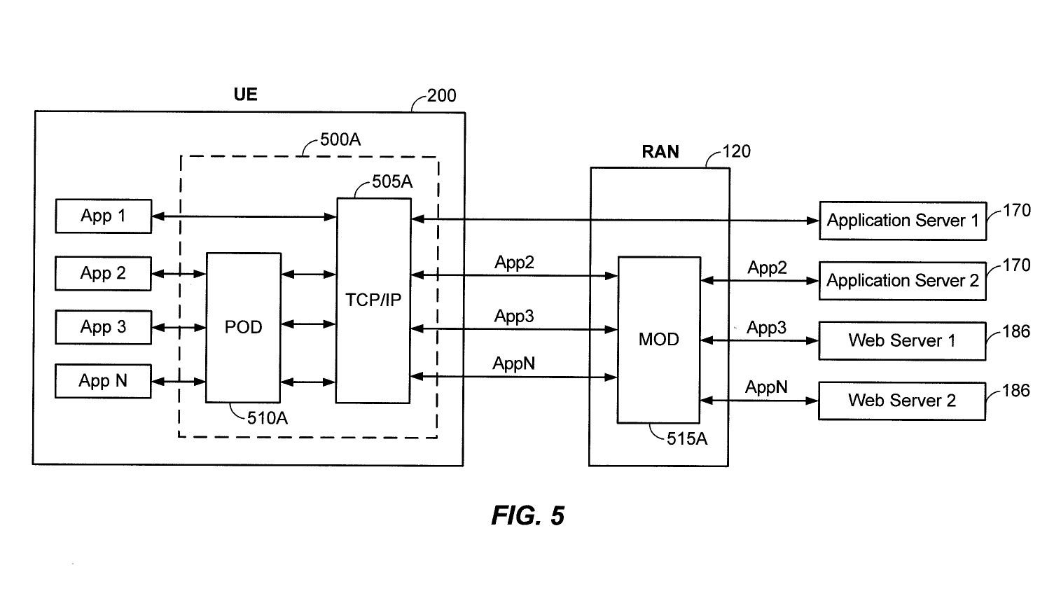

FIG. 5 illustrates a client-server architecture in accordance with an embodiment of the present invention. Referring to FIG. 5, UE 200 includes a plurality of mobile applications 1 . . . N and a transport layer 500A. The transport layer 500A is configured to convert data from mobile applications 1 . . . N into packets for transmission to the access network 120. The transport layer 500A includes a conventional Transmission Control. Protocol (TCP)/Internet Protocol (IP) layer or stack 505A, whereby the TCP/IP 505A is an example of a transport layer stack. As is known in the art, UE-originated data can be forwarded by any of the mobile applications 1 . . . N to the TCP/IP stack 505A (hereinafter referred to as TCP/IP 505A) and then converted into data packets which are queued for transmission to specified target servers (e.g., a Facebook server, a Netflix server, etc.) by the UE 200. Similarly, UE-terminated data that arrives from one or more external servers arrives at the TCP/IP 505A from which it can be disseminated to any of the mobile applications The transport layer 500A further includes a proxy on device (POD) 510A. The POD 510A is configured to interface with one or more of the mobile applications 1 . . . N and to execute a set of rules to determine whether data being exchanged between a particular mobile application and the TCP/IP 505A is permitted to be exchanged directly (i.e., without POD-enforced modifications), or whether the data will undergo a specialized handling procedure at the POD 510A. FIG. 5 illustrates an example whereby data for application 1 is permitted to be exchanged directly with the TCP/IP 505A (without POD involvement), and whereby data for applications 2 . . . N is first processed by the POD 510A. As will be described in greater detail below, the specialized handling procedure (or POD-MOD protocol) implemented by the POD 510A for UE-originated data can include data compression and also re-directing any data packet transmissions from the target server specified by the respective mobile application to a Mobile Optimized Data (MOD) server 515A, and the specialized handling procedure (or POD-MOD protocol) implemented by the POD 510A for UE-terminated data can include data decompression to undo compression that was implemented at the MOD 515A.

Further illustrated in FIG. 5 is the RAN 120. While the structural components (e.g., Node Bs, etc.) of the RAN 120 are not illustrated in FIG. 5 in detail, the RAN 120 is shown as including the MOD 515A. The MOD 515A can be implemented at different network locations of the RAN 120, including but not limited to a serving Node B of UE 200, an RNC, and so on. While not shown in FIG. 5, it is also possible that the MOD 51.5A could be moved outside of the RAN 120 so as to be implemented as an Internet destination within the Internet 175. As will be explained in greater detail below, the MOD 515A is responsible for interfacing with the POD 510A on UE 200, For UE-originated data, the MOD 515A receives the data packets from the POD 510A in a compressed format, which the MOD 515A can then decompress for transmission to the intended target server of the respective data packets. For UE-terminated data, the MOD 515A obtains data packets from an external source in a non-compressed format, the MOD 515A compresses the data packets, the MOD 515A then delivers the compressed data packets to UE 200 whereby the POD 510A can decompress the data for delivery to the intended target mobile application of the respective data packets. As used herein the compressed format can correspond to any modified data format that enhances or optimizes media payloads being exchanged between the POD 510A and the MOD 515A. Accordingly, from the perspective of both the individual mobile applications executing on UE 200 and the target servers that receive the data packets (either after the decompression by the MOD 515A or directly from TCP/IP 505A without POD or MOD involvement), the operations of the POD 510A and MOD 51.5A are logically or programmatically transparent. In other words, while the data payload itself is different via the specialized POD-MOD protocol (or compression), the end-to-end handling of the data payload can be the same despite the use of the MOD-POD protocol.

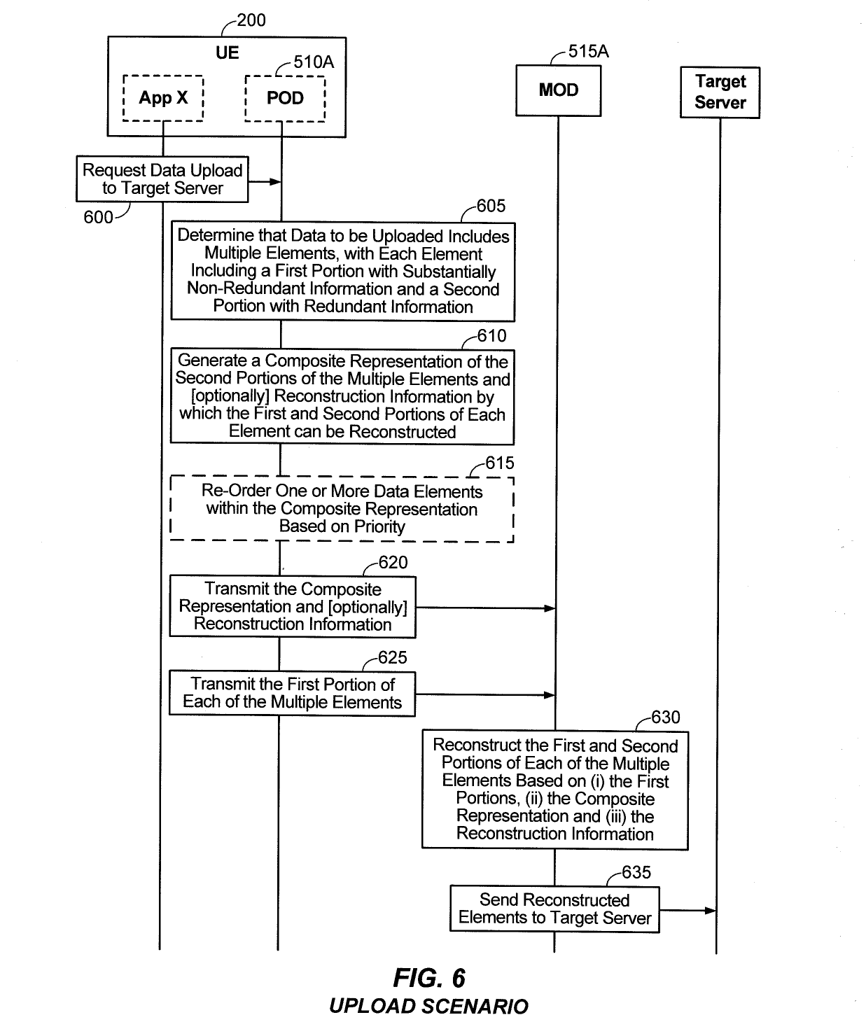

FIG. 6 illustrates a process of uploading data from a given application (“App X”) that is executing on UE 200 to a given target server (e.g., one of application servers 170, one of web servers 186, etc.) via the MOD 515A in accordance with an embodiment of the invention.

Referring to FIG. 6, App X requests data to be uploaded to the target server, 600. In FIG. 6, assume that the POD 510A determines to field App X's data upload request itself, such that App X's data upload request is handled by the POD 510A via the POD-MOD protocol instead of being routed to the TCP/IP stack 505A in a conventional manner. In an example, the POD 510A may execute one or more POD-enforceable rules to determine that App X's data upload request should be processed via the POD-MOD protocol (e.g., always process App X's data upload requests via the POD-MOD protocol, process App X's data upload requests via the POD-MOD protocol whenever UE 200 is 4G or WiFi-connected, etc.).

At 605, the POD 510A determines that the data that App X has requested to be uploaded to the target server includes multiple elements, with each of the multiple elements including a first portion with substantially non-redundant (e.g., unique) information, and a second portion with redundant information relative to other elements. For example, App X may be operated by a user that has just taken 150 pictures at a wedding reception. Each individual picture has image content that would fall under the first portion because each picture includes substantially non-redundant image data. On the other hand, each individual picture is also tagged with metadata that falls under the second portion. For example, a timestamp corresponding to the year that the 150 pictures were captured may be the same for each of the 150 pictures (barring a late wedding reception on New Years Eve), a geotag of the 150 pictures would be substantially the same (e.g., similar longitude and latitude coordinates for each of the 150 pictures), a weather-tag indicating weather conditions where the 150 picture were taken would likely be substantially the same, and so on. Of course, other types of metadata commonly associated with image files could vary from picture to picture, such as time of day and so on.

At 610, the POD 510A generates a composite representation of the second portions of the multiple elements and (optionally) reconstruction information by which the first and second portions of each element can be reconstructed. The generation of the reconstruction information can be optional at 610 because, in at least one example, one or more predefined reconstruction rules can be associated with the composite representation, in which case the POD 510A need not generate the reconstruction information from scratch. For example, using the picture example from above, an example of a predefined reconstruction rule can be to omit redundant metatags in successive pictures. Thus, if pictures 1 . . . 70 are each associated with a geotag at location #1 while pictures 71 . . . 150 are each associated with a geotag at location #2, the predefined reconstruction rule can be to assume that any picture without a geotag maps to the closest preceding geotag. Thereby, picture #1 includes a geotag for location #1 while pictures 2 . . . 70 include no geotag and are associated with the geotag for location #1 because picture #1's geotag is the closest preceding geotag, and picture #71 includes a geotag for location #2 while pictures 72 . . . 150 include no geotag and are associated with the geotag for location #2 because picture #71's geotag is the closest preceding geotag, and so on. However, in another example, the composite representation may be generated in a custom or data-specific manner, in which case the reconstruction information can be generated to ensure that the composite representation can be properly reconstructed into the first and second portions of each element.

In a first example of 610 of FIG. 6, assume that App X requests that image files #1 through #5 to be uploaded to the target server at 600, and that image files #1 through #5 are configured as shown in Table 1:

TABLE 1
Example of Fields with a Set of Image Files

| | | | | Time | Time |
|---|---|---|---|---|---|
| | Payload | Geotag | Weathertag | (Year) | of Day |
| Image | Payload #1 | Longitude: X | Rainy | 2012 | 4:56 PM |
| #1 | | Latitude: Y | | | |
| Image | Payload #2 | Longitude: X | Rainy | 2012 | 4:57 PM |
| #2 | | Latitude: Y | | | |
| Image | Payload #3 | Longitude: X | Cloudy | 2012 | 4:59 PM |
| #3 | | Latitude: Y | | | |
| Image | Payload #4 | Longitude: X | Cloudy | 2012 | 5:06 PM |
| #4 | | Latitude: Y | | | |
| Image | Payload #5 | Longitude: X | Cloudy | 2012 | 5:08 PM |
| #5 | | Latitude: Y | | | |

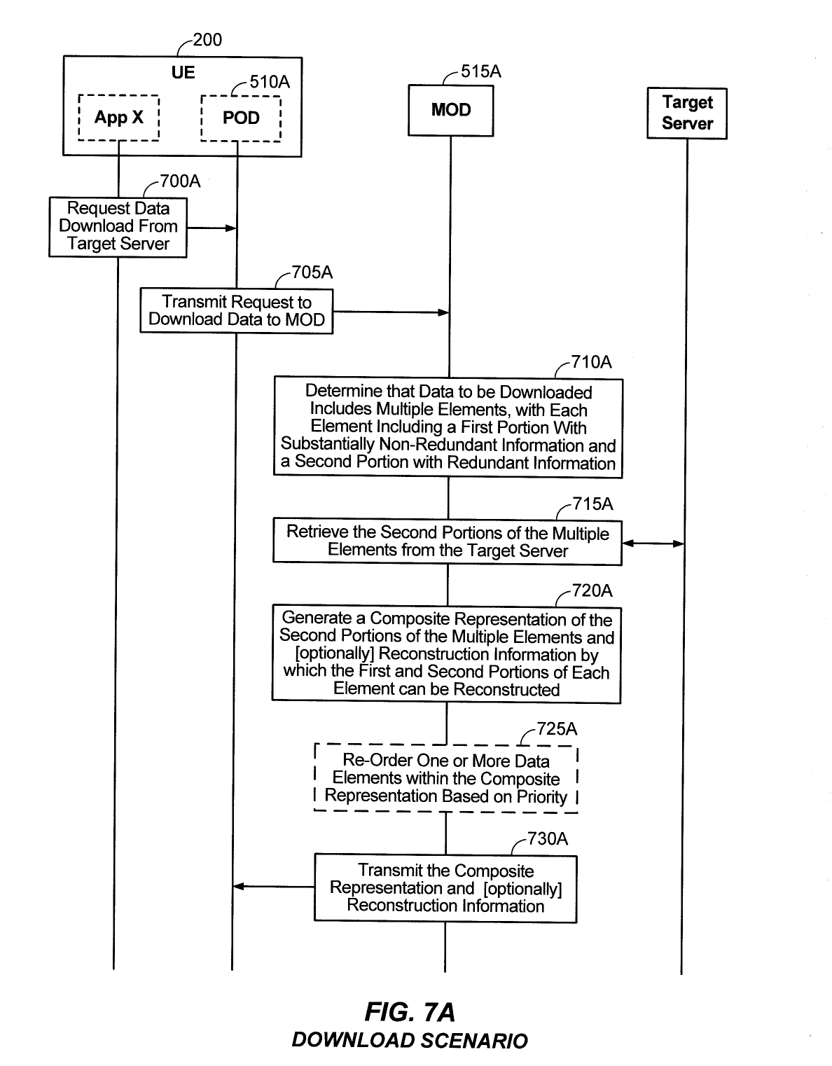

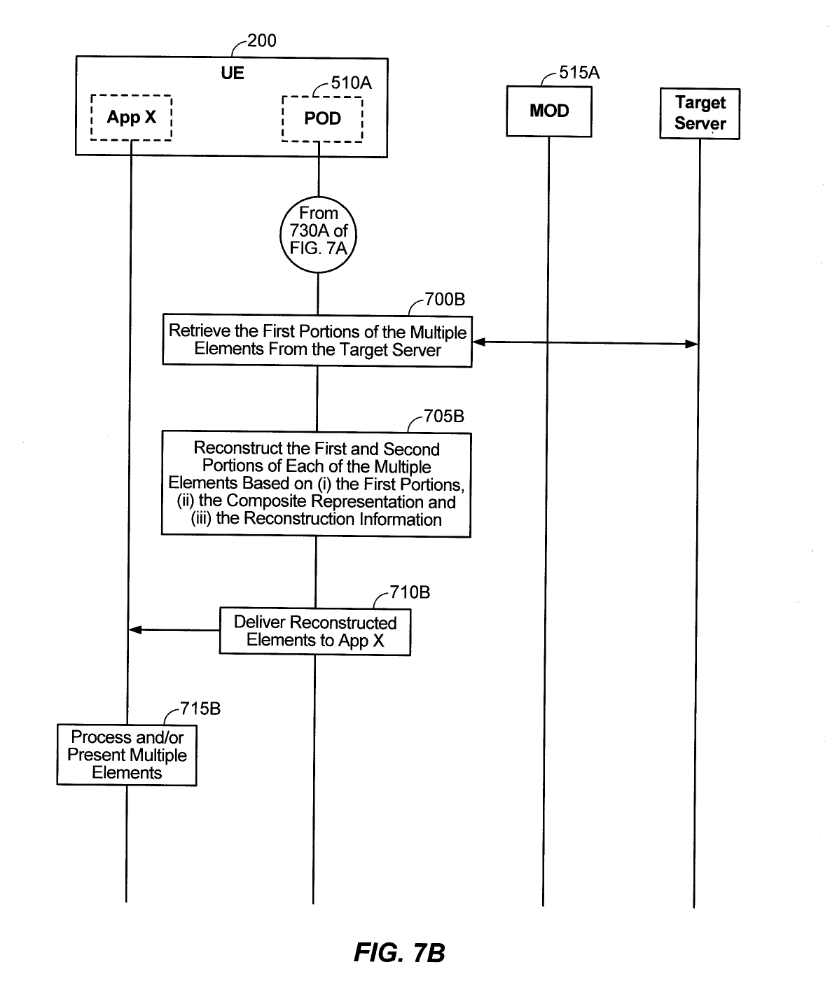

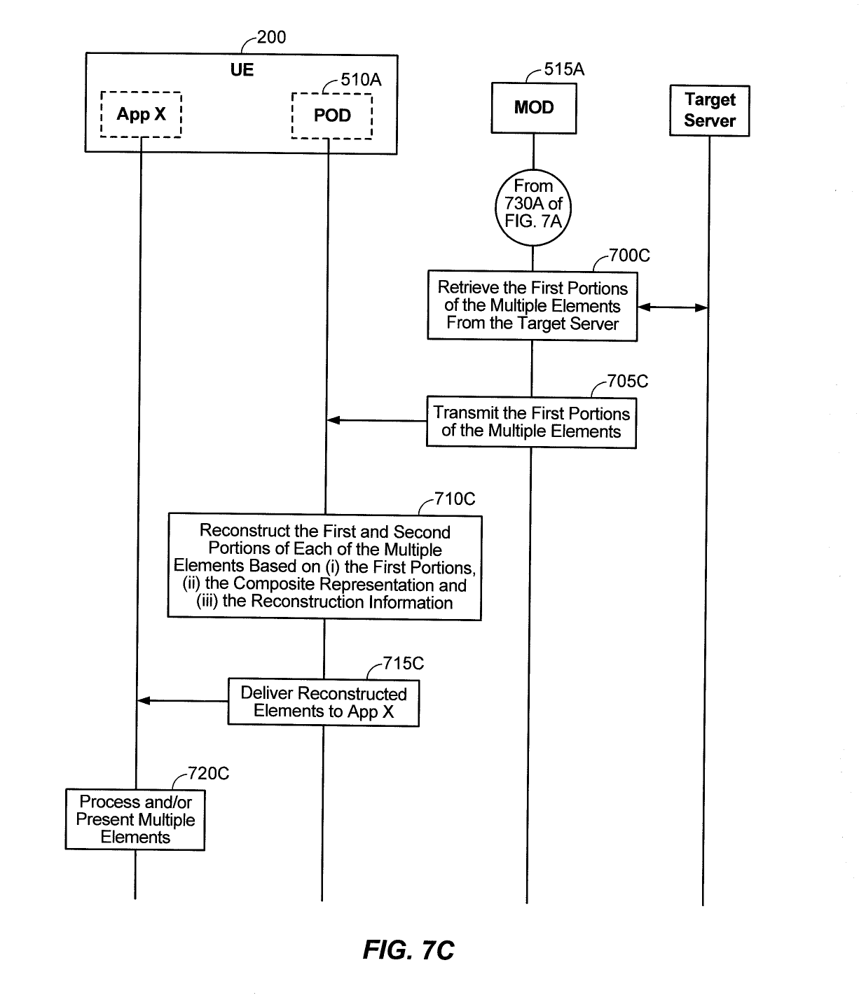

With Table 1 as an example, the payload fields, weather tag fields and time of day fields vary between some of image files #1 through #5, and thereby these respective fields fall under the first portions of the multiple elements because their content cannot be generalized across the set of image files #1 through #5 to form a composite representation of each image file. On the other hand, the geotag and time of year fields are the same for each of image files #1 through #5. Thereby, the composite representation of image files #1 through #5 can be [Geotag: (Longitude X, Latitude Y), Time (Year): 2012], and the reconstruction information (e.g., which can be based upon one or more predefined reconstruction rules or generated at 720A in a custom manner as will be discussed below with respect to FIG. 7A) can include instructions to populate the second portions (i.e., the Geotag and Time (Year) fields) of image files #1 and #5 with data from the composite representation.

After identifying the information to be contained in the composite representation at 610, the POD 510A selectively re-orders one or more data elements within the composite representation based on priority, 615. Generally, the re-ordering of 615 attempts to put higher priority fields within the composite representation before lower priority fields. The respective priorities of the fields can be established by default (e.g., a user identity of the cameraman is higher priority than an ambient weather field so that the user identity can be tagged by Facebook at the time of upload, whereby the weather where the picture was taken is of lower importance, etc.), or alternatively can be explicitly told to the POD 510A by the target server. For example, Facebook may place a high value on the locations where images are captured and may thereby allocate a higher priority to the geotag field as compared to the weather field. Further, the optional re-ordering of 615 may not only de-prioritize fields deemed to be less relevant to the target server, but may exclude these fields altogether in an embodiment. For example, assume that image files to be uploaded to a Facebook server for distribution over the Facebook social network are captured by a camera on UE 200 with a location field (or geotag). However, the user of UE 200 has privacy settings on Facebook that block location sharing. In this case, because Facebook is forbidden to gather or disseminate the location information, the location field itself can be omitted from the composite representation during the re-ordering of 615. It will be appreciated that the re-ordering of the fields within the composite representation is an optional procedure, and that in other embodiments all of the fields could simply be combined and compressed together in a non-ordered format that would not factor the individual priorities of the constituent fields.

The POD 510A transmits the composite representation and (optionally) the reconstruction information for the multiple elements to the MOD 515A at 620. The transmission of the reconstruction information is optional at 620 because in at least one embodiment the reconstruction information can correspond to one or more predefined reconstruction rules that do not need to be expressly conveyed from the POD 510A to the MOD 515A. Rather, the POD 510A can simply rely upon the MOD 515A to be aware of the one or more predefined reconstruction rules without expressly notifying the MOD 515A. Alternatively, the reconstruction information can be explicitly transmitted to the MOD 515A by the POD 510A at 620 (e.g., in case the POD 510A did not use predefined reconstruction rules to generate the composite representation, etc.). In either case, the transmission of 620 is sufficient to indicate the reconstruction information to the MOD 515A, although it will be appreciated that this indication can be implicit or explicit for the reasons noted above. Receipt of the composite representation (and potentially the reconstruction information as well) puts the MOD 515A on notice that the corresponding first portions of the multiple elements will be arriving at the MOD 515A and are to be combined (or reconstructed) using the composite representation based on the reconstruction information. Accordingly, the POD 510A transmits the first portion of each of the multiple elements to the MOD 515A, 625. In the example given with respect to Table 1 above, the first portions transmitted at 625 omit the geotag and time of year fields because these fields will be merged with (or reconstructed into) the image files by the MOD 515A using the composite representation. The MOD 515A then reconstructs the first and second portions of each of the multiple elements based on (i) the first portions, (ii) the composite representation and (iii) the reconstruction information, 630. Again, in the example given with respect to Table 1 above, the reconstruction includes populating the geotag and time of year fields from the composite representation into each of image files #1 through #5. The MOD 515A then transmits the reconstructed multiple elements to the target server, 635. Thus, the operation of the POD 510A and the MOD 515A is transparent from the perspective of both App X and the target server.

FIG. 7A illustrates a process of uploading data to a given application (“App X”) that is executing on UE 200 from a given target server (e.g., one of application servers 170, one of web servers 186, etc.) via the MOD 515A in accordance with an embodiment of the invention.

Referring to FIG. 7A, App X requests data to be downloaded from the target server, 700A. In FIG. 7A, assume that the POD 510A determines to field App X's data download request itself, such that App X's data download request is handled by the POD 5 WA via the POD-MOD protocol instead of being routed to the TCP/IP stack 505A in a conventional mariner. In an example, the POD 510A may execute one or more POD-enforceable rules to determine that App X's data download request should be processed via the POD-MOD protocol (e.g., always process App X's data download requests via the POD-MOD protocol, process App X's data download requests via the POD-MOD protocol whenever UE 200 is 40 or WiFi-connected, etc.).

At 705A, the POD 510A transmits App X's data download request to the MOD 515A. The MOD 515A receives App X's data download request and determines that the data that App X has requested to be downloaded from the target server includes multiple elements, with each of the multiple elements including a first portion with substantially non-redundant (e.g., unique) information, and a second portion with redundant information relative to other elements, 710A. The determination of 710A can be based on the type of files requested for download by the data download request from App X, or alternatively can be notified to the MOD 515A by the target server after the MOD 515A relays the data download request to the target server. For example, App X may be requesting download of a set of 150 pictures from a wedding reception that is stored on the target server. Each individual picture has image content that would fall under the first portion because each picture includes substantially non-redundant image data. On the other hand, each individual picture is also tagged with metadata that falls under the second portion. For example, a timestamp corresponding to the year that the 150 pictures were captured may be the same for each of the 150 pictures (barring a late wedding reception on New Years Eve), a geotag of the 150 pictures would be substantially the same (e.g., similar longitude and latitude coordinates for each of the 150 pictures), a weather-tag indicating weather conditions where the 150 picture were taken would likely be substantially the same, and so on. Of course, other types of metadata commonly associated with image files could vary from picture to picture, such as time of day and so on.

At 715A, the MOD 515A retrieves at least the second portions of the multiple elements from the target server. In the image file example, the MOD 515A may retrieve all metadata associated with each of the multiple elements at 715A. It is also possible (but not necessary) that the MOD 515A will also retrieve the first portions of the multiple elements. In particular, FIG. 7B illustrates an example whereby the first portions of the multiple elements are not relayed to the POD 510A via the MOD 515A, whereby FIG. 7C illustrates an example whereby the first portions of the multiple elements are relayed to the POD 510A via the MOD 515A and thereby could be conveyed to the MOD 515A as part of the transfer that occurs at 715A.

Referring to FIG. 7A, the MOD 515A generates a composite representation of the second portions of the multiple elements and (optionally) reconstruction by which the first and second portions of each element can be reconstructed, 720A. Similar to 610 of FIG. 6, the generation of the reconstruction information can be optional at 720A because, in at least one example, one or more predefined reconstruction rules can be associated with the composite representation, in which case the MOD 515A need not generate the reconstruction information from scratch. For example, using the picture example from above, an example of a predefined reconstruction rule can be to omit redundant metatags in successive pictures. Thus, if pictures 1 . . . 70 are each associated with a geotag at location #1 while pictures 71 . . . 150 are each associated with a geotag at location #2, the predefined reconstruction rule can be to assume that any picture without a geotag maps to the closest preceding geotag. Thereby, picture #1 includes a geotag for location #1 while pictures 2 . . . 70 include no geotag and are associated with the geotag for location #1 because picture #1's geotag is the closest preceding geotag, and picture #71 includes a geotag for location #2 while pictures 72 . . . 150 include no geotag and are associated with the geotag for location #2 because picture #71's geotag is the closest preceding geotag, and so on. However, in another example, the composite representation may be generated in a custom or data-specific manner, in which case the reconstruction information can be generated to ensure that the composite representation can be properly reconstructed into the first and second portions of each element.

Similar to 610 of FIG. 6, with Table 1 (above) as an example, the payload fields, weathertag fields and time of day fields vary between some of image files #1 through #5, and thereby these respective fields fall under the first portions of the multiple elements because their content cannot be generalized across the set of image files #1 through #5 to form a composite representation of each image file, On the other hand, the geotag and time of year fields are the same for each of image files #1 through #5. Thereby, the composite representation of image files #1 through #5 can be [Geotag: (Longitude X, Latitude Y), Time (Year): 2012], and the reconstruction information (e.g., which can be based upon one or more predefined reconstruction rules or generated at 720A in a custom manner) can include instructions to populate the second portions (i.e., the Geotag and Time(Year) fields) of image files #1 and #5 with data from the composite representation.

After identifying the information to be contained in the composite representation at 720A, the MOD 515A selectively re-orders one or more data elements within the composite representation based on priority, 725A. Generally, the re-ordering of 725A attempts to put higher priority fields within the composite representation before lower priority fields. The respective priorities of the fields can be established by default, or alternatively can be based upon explicit or implicit user profile information associated with an operator or user of UE 200. For example, in the image file example, the location or geotag field may be de-prioritized if the target user does not frequently use this feature. Further, the optional re-ordering of 725A can not only de-prioritize fields deemed to be less relevant to the target server, but can exclude these fields altogether in an embodiment. For example, assume that image files to be downloaded to UE 200 includes a weather field indicating weather conditions where the respective images were captured, but that UE 200 is not capable of presenting weather information. In this case, the weather field itself can be omitted from the composite representation during the re-ordering of 725A. It will be appreciated that the re-ordering of the fields within the composite representation at 725A is an optional procedure, and that in other embodiments all of the fields could simply be combined and compressed together in a non-ordered format that would not factor the individual priorities of the constituent fields.

Referring to FIG. 7A, the MOD 515A transmits the composite representation and (optionally) the reconstruction information for the multiple elements to the POD 510A at 730A. Similar to 620, the transmission of the reconstruction information is optional at 730A because in at least one embodiment the reconstruction information can correspond to one or more predefined reconstruction rules that do not need to be expressly conveyed from the MOD 515A to the POD 510A. Rather, the MOD 515A can simply rely upon the POD 510A to be aware of the one or more predefined reconstruction rules without expressly notifying the MOD 515A. Alternatively, the reconstruction information can be explicitly transmitted to the POD 510A by the MOD 515A at 730A (e.g., in case the MOD 515A did not use predefined reconstruction rules to generate the composite representation, etc.). In either case, the transmission of 730A is sufficient to indicate the reconstruction information to the POD 510A, although it will be appreciated that this indication can be implicit or explicit for the reasons noted above. Receipt of the composite representation (and potentially the reconstruction information as well) puts the POD 510A on notice that the corresponding first portions of the multiple elements are to be combined (or reconstructed) by the POD 510A using the composite representation based on the reconstruction information.

FIG. 7B illustrates a continuation of the process of FIG. 7A in accordance with an embodiment of the invention. Referring to FIG. 7B, the POD 510A retrieves the first portions of the multiple elements from the target server independent of the MOD 515A, 700B. As noted above, in the image file example, the first portions of the image files can include the image content as well as non-redundant metadata that does not become part of the composite representation (e.g., in Table 1, the time of day field would be part of the first portions instead of the composite representation because the time of day field varies from image file to image file). The retrieval of the first portions at 700B can occur responsive to receipt of the composite representation and (optionally) reconstruction information at 730A of FIG. 7A in an example. In other words, the reconstruction information can instruct the POD 510A to download the first portions of the multiple elements directly from the target server. The POD 510A then reconstructs the first and second portions of each of the multiple elements based on (i) the first portions, (ii) the composite representation and (iii) the reconstruction information, 705B. Again, in the example given with respect to Table 1 above, the reconstruction includes populating the geotag and time of year fields from the composite representation into each of image files #1 through #5. The POD 510A then delivers the reconstructed multiple elements to App X, 710B, and App X processes and/or presents the multiple elements, 71511. Thus, the operation of the POD 510A and the MOD 515A is transparent from the perspective of both App X and the target server.

FIG. 7C illustrates another continuation of the process of FIG. 7A in accordance with an embodiment of the invention. FIG. 7C is similar to FIG. 7B except that the first portions of the multiple elements are conveyed, to the POD 510A via the MOD 515A in FIG. 7C.

Referring to FIG. 7C, the MOD 515A retrieves the first portions of the multiple elements from the target server, 700C. As noted above, in the image file example, the first portions of the image files can include the image content as well as non-redundant metadata that does not become part of the composite representation (e.g., in Table 1, the time of day field would be part of the first portions instead of the composite representation because the time of day field varies from image file to image file). The retrieval of the first portions at 700C can occur in conjunction with the MOD 515A's retrieval of the second portions at 715A of FIG. 7A, or alternatively can be retrieved at some point in time after the second portions are retrieved. After retrieving the first portions of the multiple elements at 700C, the MOD 515A transmits the first portions of the multiple elements to the POD 510A, 705C. In an example, the transmissions of the first portions of the multiple elements at 705C can occur after the transmission of the composite representation and (optionally) reconstruction information at 730A of FIG. 7A so that, upon receipt of the first portions of the multiple elements, the POD 510A knows how the first and second portions of the multiple elements can be reconstructed.

At 710C, the POD 510A reconstructs the first and second portions of each of the multiple elements based on (i) the first portions, (ii) the composite representation and (iii) the reconstruction information. Again, in the example given with respect to Table 1 above, the reconstruction includes populating the geotag and time of year fields from the composite representation into each of image files #1 through #5. The POD 510A then delivers the reconstructed multiple elements to App X, 715C, and App X processes and/or presents the multiple elements, 720C. Thus, the operation of the POD 510A and the MOD 515A is transparent from the perspective of both App X and the target server.

While each of the above-described embodiments are described whereby the POD 510A communicates directly with the MOD 515A (e.g., in FIG. 6, the POD 510A deconstructs the multiple elements so that they can be reconstructed by the MOD 515A for delivery to the target server, and vice versa in FIGS. 7A-7C), in other embodiments the POD 510A can selectively bypass interaction with the MOD 515A. For example, if the MOI) 515A is determined to be highly loaded or otherwise incapable of servicing the POD 510A, the POD 510A can determine to bypass MOD interaction. In context with FIG. 6, for instance, a MOD assessment can be made after 600, and if the POI) 510A determines to bypass the MOD 515A based on the MOD assessment, the POD 510A refrains from implementing 605 through 635 and instead simply transmits the multiple elements to the target server without deconstruction while bypassing the MOD 515A (e.g., via the TCP/IP stack 505A without intervention by the POD 510A). Likewise, in context with FIGS. 7A-7C, for instance, a MOD assessment can be made after 700A, and if the POD 510A determines to bypass the MOD 515A based on the MOD assessment, the POD 510A transmits the download request of 705A to the target server directly instead of to the MOD 515A, thereby facilitating the target server to respond with the requested data directly to UE 1 (e.g., via the TCP/IP stack 505A without POD intervention) without deconstruction while bypassing the MOD 515A. In an example, the MOD 51.5A can notify the POD 51.0A with regard to its ability to handle the data requests which facilitates the 510A to decide whether or not to mediate the data requests via the MOD 515A or directly with the target server.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of communicating data, comprising:
obtaining data from a first device for transmission to a second device;
determining that the data for transmission includes multiple elements, wherein each of the multiple elements includes (i) a first portion of substantially non-redundant information and (ii) a second portion with information that is redundant to each of the multiple elements;
generating a composite representation of the redundant information; and
transmitting the composite representation of the redundant information to the second device, the transmitted composite representation configured to be used with reconstruction information by which the second device can reconstruct the first and second portions for each of the multiple elements based on the composite representation of the redundant information and the first portions of the multiple elements.

2. The method of claim 1,
wherein the data for transmission corresponds to data to be uploaded from the first device to a target server,
wherein the first device corresponds to a user equipment (UE) and the second device corresponds to a proxy server,
wherein the obtaining, determining, generating and transmitting steps are performed at a proxy on device (POD) module on the UE.

3. The method of claim 1,
wherein the data for transmission corresponds to data to be downloaded from the first device to the second device,
wherein the first device corresponds to a target server and the second device corresponds to a user equipment (UE),
wherein the obtaining, determining, generating and transmitting steps are performed at a proxy server.

4. The method of claim 1, further comprising:
re-ordering data elements within the composite representation based on priority levels associated with the re-ordered data elements,
wherein the transmitting transmits the composite representation with the re-ordered data elements.

5. The method of claim 4, wherein the priority levels are designated by a user of the first device or an operator of the second device.

6. The method of claim 4, wherein the priority levels are designated by a default priority scheme.

7. The method of claim 4, wherein the re-ordering de-prioritizes at least one data element by moving the at least one data element to a different position in an order of the re-ordered data elements.

8. The method of claim 4, wherein the re-ordering de-prioritizes at least one data element by excluding the at least one data element from inclusion within the re-ordered data elements.

9. The method of claim 1,
wherein the first portion includes a payload portion of the multiple elements, and
wherein the second portion includes header information and/or metadata that is shared by two or more of the multiple elements.

10. The method of claim 1, wherein the reconstruction information is transmitted along with the composite representation.

11. The method of claim 1, wherein the composite representation is transmitted without the reconstruction information.

12. The method of claim 11, wherein the reconstruction information is omitted from transmission based upon an expectation that the second device can independently determine the reconstruction information as one or more predefined reconstruction rules for reconstructing the first and second portions for each of the multiple elements.

13. A method of communicating data, comprising:
receiving a composite representation of information that is redundant for each of multiple elements of data, each of the multiple elements including a separate portion of substantially non-redundant information;
determining reconstruction information by which the composite representation of the redundant information can be used in conjunction with the separate portions of the substantially non-redundant information to reconstruct the multiple elements;
receiving the separate portions of the substantially non-redundant information;
reconstructing the multiple elements based on the received separate portions, the reconstruction information and the composite representation of the redundant information; and
delivering the reconstructed multiple elements to a target.

14. The method of claim 13,
wherein the data corresponds to data to be downloaded to a user equipment (UE) from a target server,
wherein the composite representation and the received separate portions are received from a proxy server,
wherein the receiving the composite representation, determining, receiving the separate portions, reconstructing and delivering steps are performed at a proxy on device (POD) module on the UE, and
wherein the target corresponds to a client application on the UE.

15. The method of claim 13,
wherein the data corresponds to data to be downloaded to a user equipment (UE) from a target server,
wherein the composite representation is received from a proxy server,
wherein the received separate portions are received from the target server,
wherein the receiving the composite representation, determining, receiving the separate portions, reconstructing and delivering steps are performed at a proxy on device (POD) module on the UE, and
wherein the target corresponds to a client application on the UE.

16. The method of claim 13,
wherein the data corresponds to data to be uploaded from a user equipment (UE) to a target server,
wherein the composite representation and the received separate portions are received from the UE,
wherein the receiving the composite representation, determining, receiving the separate portions, reconstructing and delivering steps are performed at a proxy server, and
wherein the target corresponds to the target server.

17. The method of claim 13,
wherein the received separate portions include payload portions of the multiple elements, and
wherein the composite representation includes indications of header information and/or metadata that is shared by two or more of the multiple elements.

18. The method of claim 13, wherein the reconstruction information is received along with the composite representation.

19. The method of claim 13, wherein the reconstruction information is not received along with the composite representation.

20. The method of claim 19, wherein the reconstruction information corresponds to one or more predefined reconstruction rules that are available at an entity executing the determining step.

21. An apparatus configured to communicate data, comprising:
means for obtaining data from a first device for transmission to a second device;
means for determining that the data for transmission includes multiple elements, wherein each of the multiple elements includes (i) a first portion of substantially non-redundant information and (ii) a second portion with information that is redundant to each of the multiple elements;
means for generating a composite representation of the redundant information; and
means for transmitting the composite representation of the redundant information to the second device, the transmitted composite representation configured to be used with reconstruction information by which the second device can reconstruct the first and second portions for each of the multiple elements based on the composite representation of the redundant information and the first portions of the multiple elements.

22. The apparatus of claim 21,
wherein the data for transmission corresponds to data to be uploaded from the first device to a target server,
wherein the first device corresponds to a user equipment (UE) and the second device corresponds to a proxy server,
wherein the apparatus corresponds to the UE.

23. The apparatus of claim 21,
wherein the data for transmission corresponds to data to be downloaded from the first device to the second device,
wherein the first device corresponds to a target server and the second device corresponds to a user equipment (UE),
wherein the apparatus corresponds to a proxy server.

24. An apparatus configured to communicate data, comprising:
means for receiving a composite representation of information that is redundant for each of multiple elements of data, each of the multiple elements including a separate portion of substantially non-redundant information;
means for determining reconstruction information by which the composite representation of the redundant information can be used in conjunction with the separate portions of the substantially non-redundant information to reconstruct the multiple elements;
means for receiving the separate portions of the substantially non-redundant information;
means for reconstructing the multiple elements based on the received separate portions, the reconstruction information and the composite representation of the redundant information; and
means for delivering the reconstructed multiple elements to a target.

25. The apparatus of claim 24,
wherein the data corresponds to data to be downloaded to a user equipment (UE) from a target server,
wherein the composite representation and the received separate portions are received from a proxy server,
wherein the apparatus corresponds to the UE, and
wherein the target corresponds to a client application on the UE.

26. The apparatus of claim 24,
wherein the data corresponds to data to be downloaded to a user equipment (UE) from a target server,
wherein the composite representation is received from a proxy server,
wherein the received separate portions are received from the target server,
wherein the apparatus corresponds to the UE, and
wherein the target corresponds to a client application on the UE.

27. The apparatus of claim 24,
wherein the data for transmission corresponds to data to be uploaded from a user equipment (UE) to a target server,
wherein the composite representation and the received separate portions are received from the UE,
wherein the apparatus corresponds to a proxy server, and
wherein the target corresponds to the target server.

28. An apparatus configured to communicate data, comprising:
logic configured to obtain data from a first device for transmission to a second device;
logic configured to determine that the data includes multiple elements, wherein each of the multiple elements includes (i) a first portion of substantially non-redundant information and (ii) a second portion with information that is redundant to each of the multiple elements;
logic configured to generate a composite representation of the redundant information; and
logic configured to transmit the composite representation of the redundant information to the second device, the transmitted composite representation configured to be used with reconstruction information by which the second device can reconstruct the first and second portions for each of the multiple elements based on the composite representation of the redundant information and the first portions of the multiple elements.

29. The apparatus of claim 28,
wherein the data for transmission corresponds to data to be uploaded from the first device to a target server,
wherein the first device corresponds to a user equipment (UE) and the second device corresponds to a proxy server,
wherein the apparatus corresponds to the UE.

30. The apparatus of claim 28,
wherein the data for transmission corresponds to data to be downloaded from the first device to the second device,
wherein the first device corresponds to a target server and the second device corresponds to a user equipment (UE),
wherein the apparatus corresponds to a proxy server.

31. An apparatus configured to communicate data, comprising:
logic configured to receive a composite representation of information that is redundant for each of multiple elements of data, each of the multiple elements including a separate portion of substantially non-redundant information;
logic configured to determine reconstruction information by which the composite representation of the redundant information can be used in conjunction with the separate portions of the substantially non-redundant information to reconstruct the multiple elements;
logic configured to receive the separate portions of the substantially non-redundant information;
logic configured to reconstruct the multiple elements based on the received separate portions, the reconstruction information and the composite representation of the redundant information; and
logic configured to deliver the reconstructed multiple elements to a target.

32. The apparatus of claim 31,
wherein the data corresponds to data to be downloaded to a user equipment (UE) from a target server,
wherein the composite representation and the received separate portions are received from a proxy server,
wherein the apparatus corresponds to the UE, and
wherein the target corresponds to a client application on the UE.

33. The apparatus of claim 31,
wherein the data corresponds to data to be downloaded to a user equipment (11E) from a target server,
wherein the composite representation is received from a proxy server,
wherein the received separate portions are received from the target server,
wherein the apparatus corresponds to the UE, and
wherein the target corresponds to a client application on the UE.

34. The apparatus of claim 31,
wherein the data for transmission corresponds to data to be uploaded from a user equipment (UE) to a target server,
wherein the composite representation and the received separate portions are received from the UE,
wherein the apparatus corresponds to a proxy server, and
wherein the target corresponds to the target server.

35. A non-transitory computer-readable medium containing instructions stored thereon, which, when executed by an apparatus configured to communicate data, cause the apparatus to perform operations, the instructions comprising:
at least one instruction to cause the apparatus to obtain data from a first device for transmission to a second device;
at least one instruction to cause the apparatus to determine that the data for transmission includes multiple elements, wherein each of the multiple elements includes (i) a first portion of substantially non-redundant information and (ii) a second portion with information that is redundant to each of the multiple elements;
at least one instruction to cause the apparatus to generate a composite representation of the redundant information; and
at least one instruction to cause the apparatus to transmit the composite representation of the redundant information to the second device, the transmitted composite representation configured to be used with reconstruction information by which the second device can reconstruct the first and second portions for each of the multiple elements based on the composite representation of the redundant information and the first portions of the multiple elements.

36. The non-transitory computer-readable medium of claim 35,
wherein the data for transmission corresponds to data to be uploaded from the first device to a target server,
wherein the first device corresponds to a user equipment (UE) and the second device corresponds to a proxy server,
wherein the apparatus corresponds to the UE.

37. The non-transitory computer-readable medium of claim 35,
wherein the data for transmission corresponds to data to be downloaded from the first device to the second device,
wherein the first device corresponds to a target server and the second device corresponds to a user equipment (UE),
wherein the apparatus corresponds to a proxy server.

38. A non-transitory computer-readable medium containing instructions stored thereon, which, when executed by an apparatus configured to communicate data, cause the apparatus to perform operations, the instructions comprising:
at least one instruction to cause the apparatus to receive a composite representation of information that is redundant for each of multiple elements of data, each of the multiple elements including a separate portion of substantially non-redundant information;
at least one instruction to cause the apparatus to determine reconstruction information by which the composite representation of the redundant information can be used in conjunction with the separate portions of the substantially non-redundant information to reconstruct the multiple elements;
at least one instruction to cause the apparatus to receive the separate portions of the substantially non-redundant information;
at least one instruction to cause the apparatus to reconstruct the multiple elements based on the received separate portions, the reconstruction information and the composite representation of the redundant information; and
at least one instruction to cause the apparatus to deliver the reconstructed multiple elements to a target.

39. The non-transitory computer-readable medium of claim 38,
wherein the data corresponds to data to be downloaded to a user equipment (UE) from a target server,
wherein the composite representation and the received separate portions are received from a proxy server,
wherein the apparatus corresponds to the UE, and
wherein the target corresponds to a client application on the UE.

40. The non-transitory computer-readable medium of claim 38,
wherein the data corresponds to data to be downloaded to a user equipment (UE) from a target server,
wherein the composite representation is received from a proxy server,
wherein the received separate portions are received from the target server,
wherein the apparatus corresponds to the UE, and
wherein the target corresponds to a client application on the UE.

41. The non-transitory computer-readable medium of claim 38,
wherein the data corresponds to data to be uploaded from a user equipment (UE) to a target server,
wherein the composite representation and the received separate portions are received from the UE,
wherein the apparatus corresponds to a proxy server, and
wherein the target corresponds to the target server.
